(19) United States
(12) Patent Application Publication
(10) Pub. No.: US 2003/0072850 A1
(43) Pub. Date: Apr. 17, 2003

(54) Bottle cap drink mix reservoir

(76) Inventor: Edward William Burniski, Sugar Notch, PA (US)

Correspondence Address: Blackmon IPS & Law Office, 2101 Crystal Plaza Arcade PMB#289, Arlington, VA, 22202, US

(21) Appl. No.: 10/270,549

(22) Filed: Oct. 16, 2002

Related U.S. Application Data
(60) Provisional application No. 60/329,312, filed on Oct. 16, 2001.

(51) Int. Cl. A23B 4/00

(52) U.S. Cl. 426/115

(57) ABSTRACT

A drink mix dispenser includes a reservoir for drink mix and a stopper for the reservoir, all incorporated into a bottle cap. The stopper and reservoir are relatively moveable within the bottle cap, which is in turn secured to a bottle. By simple manipulations like twisting the cap onto a bottle or pushing/pulling a cap attachment, the stopper reveals an aperture within the reservoir for drink mix to be dispensed from. The all inclusive bottle caps may be provided separately from or in combination with reusable drink containers, saving storage space and creating far reduced container waste.

This application is a claims priority to earlier filed provisional Application Serial No. 60/329,312 filed Oct. 16, 2001, which is hereby incorporated by reference.

### BACKGROUND OF THE INVENTION

A. Field of the Invention

The present invention relates to a cap for a liquid container which has a reservoir containing a drink mix formula. With simple manipulation, the contents of the reservoir are dispensed and mix with the liquid of the container to form a flavored drink.

B. Description of the Prior Art

Mixtures and concentrates have been long used to prepare liquid compositions for a variety of reasons. Among these are improved storage stability, much reduced storage volume, reduced container waste, and typically commensurate cost savings. Most commonly a package is provided that includes multiple doses or servings of the mixture. To prepare the desired composition, these doses are measured out, typically by hand, and admixed with a quantity of liquid as directed. The disadvantages include the need for an additional measuring device, the typically large package of multiple doses, and commitment to a particular mix sufficient to justify purchase of the multiple-dose package.

These disadvantages, if seemingly small, are yet of such significance that many people would rather purchase pre-mixed single serving sized containers in bottles or cans, even when the majority of contents is a readily available liquid, such as water. The results generated by this choice of convenience is a well-documented source of post-consumer waste. What is needed, and what the present invention is directed towards, is a system that provides the convenience of single serving pre-mixed packaging while drastically reducing container waste.

Mixtures that are provided in rupturable packages are known in the art. Single serving envelopes are quite common. Others incorporate such packaging into devices, which typically require a sufficiently sharp puncturing member to penetrate a mix containing paper or foil package. For example, see U.S. Pat. No. 2,859,898 issued Nov. 11, 1958 to Mendenhall; U.S. Pat. No. 5,246,142 issued Sep. 21, 1993 to DiPalma et al.; U.S. Pat. No. 5,772,017 issued Jun. 0, 1998 to Kang; and U.S. Pat. No. 6,098,795 issued Aug. 8, 2000 to Mollstam et al. U.S. Pat. No. 3,924,741 provides a container with a frangible portion that must be broken to discharge ingredients for mixing. Among the disadvantages of such systems is the possibility that the ruptured package material may separate and become admixed with the desired ingredients in the final composition.

Non-rupturing devices are known, but are typically ineffective for providing a mixed beverage, as in the scent disbursement ring described by U.S. Pat. No. 5,635,229 issued Jun. 3, 1997 to Ray. The concept of releasing aroma in the act of removing a cap is described by U.S. Pat. No. 6,102,224 issued Aug. 15, 2000 to Sun et al. Again, no mixed beverage is provided. Some systems are known where a mix is provided unsealed, such as the porous article described by U.S. Pat. No. 6,024,012 issued Feb. 15, 2000 to Luzenberg, Jr. Such articles would require additional packaging to maintain contents. U.S. Pat. No. 4,526,305 issued Jul. 2, 1985 to Lykes describes an apparatus for distributing granules through slots into a plug and a cap which allows distribution into a container. The container must be squeezed since air pressure is used for distribution, and is of course open to the air.

None of the above inventions and patents, taken either singly or in combination, is seen to describe the instant invention as claimed.

### SUMMARY OF THE INVENTION

The present invention identifies common manipulations which consumers are already accustomed to making when using bottles, and provides structures which utilize these manipulations for releasing a pre-metered mixing material into a liquid container for preparing a liquid composition. Advantageously, these structures are provided in a cap for bottles. The basic elements of the present invention include: a reservoir for a pre-metered mixing substance, the reservoir having an aperture for dispensing the mixing substance; a stopper sized to close the aperture of the reservoir; and a support structure that allows relative movement of the stopper and the reservoir aperture, the support structure being securable upon a bottle. With this combination of elements, bottle caps may be distributed separate from bottles, in a light-weight compact manner, yet the disadvantages of previous mixing systems are avoided. No large container of mix and no separate measuring device are required. Further, no rupturing or frangible elements are exposed to the mixing environment of the bottle or the mixing substance itself.

One of the most common manipulations in using a bottle, is to screw a cap on or off. Appropriate bottles for use with the present invention in this regard include those of conventional design, having an exterior threaded opening, typically with a lip below the threading. The present invention provides, in one embodiment, a cap structure that includes: an interiorly threaded portion for engaging thread upon a bottle; a skirt below the threading for engaging a lip upon a bottle; a reservoir for pre-metered mixing substance having an aperture for dispensing; and a stopper positively attached through substantially rigid members to the interiorly threaded portion for engaging the aperture of the reservoir. In operation, the cap is screwed onto a bottle filled with a mixing liquid, such as water. The skirt of the present cap engages the lip of the bottle. The skirt is then removed, and the cap is further screwed to manipulate the stopper member and open the reservoir for release of the mixing substance into the bottle.

In another embodiment, no skirt is required. This cap structure includes: an interiorly threaded portion for engaging thread upon a bottle; a reservoir for pre-metered mixing substance having an aperture for dispensing; and a stopper positively attached through substantially rigid members to the interiorly threaded portion for engaging the aperture of the reservoir. Here, the reservoir is sized to frictionally engage a bottle opening. In operation, this cap is screwed upon a bottle sufficient to fix the reservoir in the bottle opening, and the cap is partially unscrewed to lift the stopper and release mixing substance into the bottle.

Another common manipulation familiar to consumers is pulling and pushing a portion of a cap, which may form a mouthpiece. This manipulation is used on water bottles in particular. One embodiment of the present invention includes a reservoir with an aperture, a support structure adapted to secure the reservoir to a bottle; and a stopper movably attached to the support structure to move from a position closing the aperture to a position exposing the aperture for dispensing. The stopper extends outside the support structure to provide a push/pull manipulatable extension. Stops may be provided to limit the travel of the stopper.

In any of the above, a conduit may be provided through the stopper to function as a drinking mouthpiece. Further, if desired, a freshness seal may be provided. Unlike seals in the prior art, removal of such a seal would not cause the pre-metered mix to escape, since it is still fully contained in the reservoir and stoppered. This seal would be removed prior to any of the above manipulations and would not be exposed to the mixing environment or substances at all.

Accordingly, it is a principal object of the invention to provide pre-metered packaged mixes which cooperate with liquid containers to conveniently and assuredly prepare a liquid composition.

It is another object of the invention to provide a bottle cap package in which a reservoir containing a mix is engaged to a bottle opening by securing the package to a bottle containing liquid, followed by manipulating a stopper member to release the mix from the reservoir.

It is yet another object of the invention to provide such a package in the form of bottle caps, in which the simple action of securing the cap to a bottle containing liquid is used to release the pre-metered amount of mix without rupture of any sealing material.

Still another object of the invention is to provide bottle cap packaging that may further include a conduit for drinking akin to a straw or a squirt bottle aperture.

It is a further object of the invention to provide mechanisms for bottle cap packaging in which manipulations required to use them are of great simplicity and familiarity.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a side sectional view of an embodiment of the bottle cap reservoir of the present invention attached to a bottle in which stopper manipulation is a screwing action.

FIG. 2 is a side sectional view of another embodiment of the bottle cap reservoir of the present invention attached to a bottle in which stopper manipulation is by a pulling/pushing action.

FIG. 3 is a side sectional view of an embodiment of the bottle cap reservoir of the present invention with a mouthpiece, manipulated as in FIG. 1.

FIG. 4 is a side sectional view of an embodiment of the bottle cap reservoir of the present invention with a mouthpiece, manipulated as in FIG. 2.

Similar reference characters denote corresponding features consistently throughout the attached drawings.

### DETAILED DESCRIPTION OF THE PREFERRED EMBODIMENT(s)

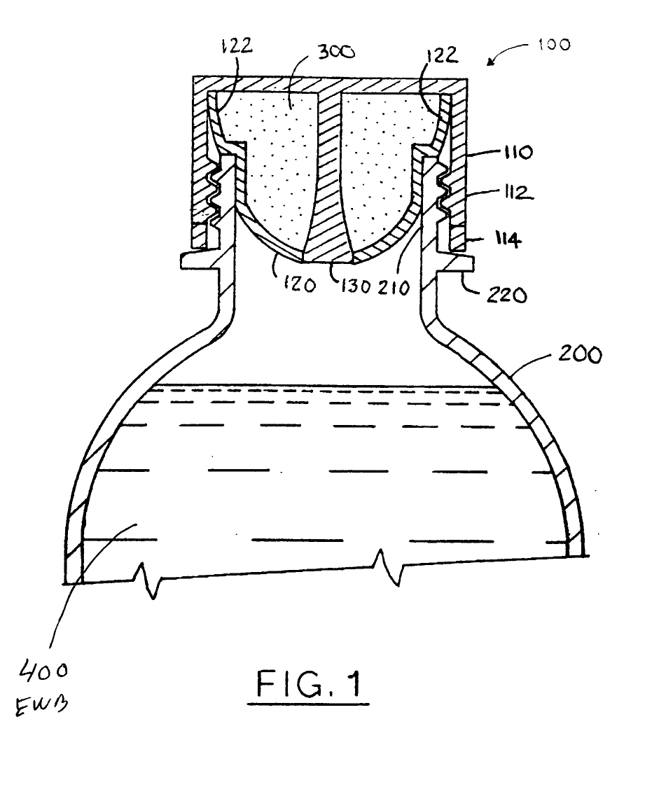

Turning to FIG. 1, the present invention provides a bottle cap 100 that includes: a support structure 110 that includes an interiorly threaded portion 112 for engaging thread 210 upon a bottle 200; a skirt 114 may be provided below the threading for engaging a lip 220 upon a bottle; a reservoir 120 for pre-metered mixing substance 300, the reservoir having an aperture for dispensing the substance; and a stopper 130 positively attached through substantially rigid members to the interiorly threaded portion for engaging the aperture of the reservoir and is substantially the same diameter as the aperture. This forms a seal between the aperture and the stopper. The stopper 130 and support structure 110 are shown as unitarily made, but need only be substantially rigidly connected. Also, the reservoir 120 preferably slopes towards the aperture to allow more efficient dispensing.

With this structure, the cap may operated in either of two ways. In a first use, the skirt 114 is preferably provided. The cap is screwed onto a bottle filled with a mixing liquid 400, such as water. The skirt of the present cap engages the lip of the bottle. The skirt is then removed, and the cap is further screwed to manipulate the stopper member and open the reservoir for release of the mixing substance into the bottle. Attachment of a skirt to the remaining cap structure may be weakened for ease in removal of the skirt by perforations, die cut or the like. Removable skirts for bottle caps are common in the art, but are generally used to resist tampering of a prepackaged bottle and cap combined. Even though the present use is for an entirely different purpose, the act of removing a skirt would be almost automatic for a consumer, and the additional screwing step would be easily mastered. The present skirt differs structurally from prior cap skirts in that no ledge for restricting removal of the cap from a bottle is provided. The reservoir may be made of sufficiently flexible material to allow support structure 110 to be further screwed downward, or only a portion of the reservoir may be made so flexible, such as extensions 122. Threading may be provided either directly on support structure 1 10 as shown, or a separate insert. The skirt, though preferable may be eliminated, as the slightly increased force required to flex extensions 122 may serve to naturally divide the screwing action into two stages.

In a second use of the embodiment of FIG. 1, no skirt is required. Here, the reservoir 120 is sized to frictionally engage a bottle opening and is slidably engaged in support structure 110. In operation, this cap is screwed upon a bottle sufficient to fix the reservoir in the bottle opening, and the cap is partially unscrewed to lift the stopper and release mixing substance into the bottle.

Of course, the structure of FIG. 1 may be further modified if only one of the above manipulations is to be used. In a preferred embodiment, the stopper 130 is tapered, such as exponentially, substantially to an end distal its attachment to support structure 110. The aperture of 120 would then also be tapered to fit the stopper, forming a more positive seal with stopper 130. Accordingly, the movement of stopper 130 would then be limited to a downward movement appropriate for the first use above. A reverse taper may be used to limit stopper movement to an upward movement appropriate for the second use above.

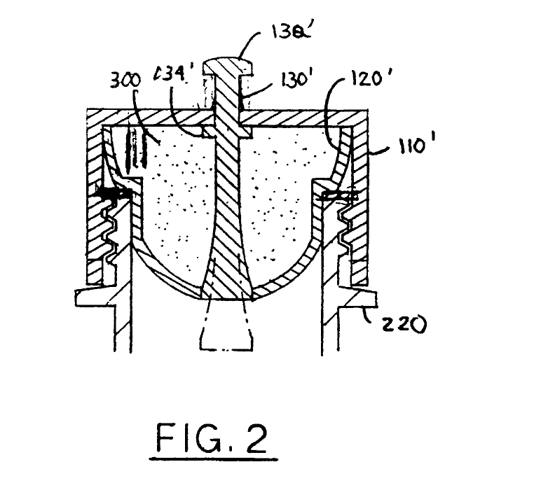

Turning to FIG. 2, the present invention further contemplates a push pull stopper in which reservoir 120′ is rigidly attached to support structure 110′; and stopper 130′ is movably engaged to the support structure. Stopper 130′ preferably includes an enlarged head portion 132′, and may further include a travel stop 134′. When head portion 132′ is present, a removable safety element (not shown) may be positioned below the head portion and the top of support structure 110′ in abutment of both.

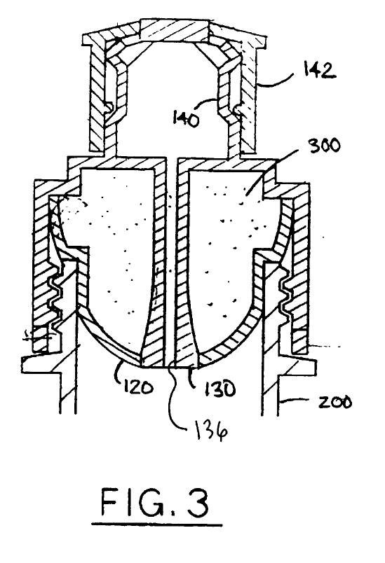

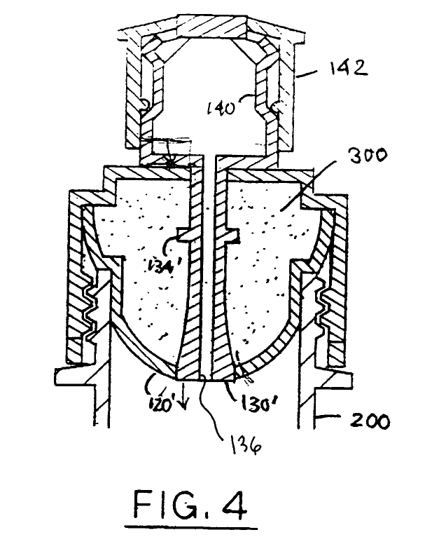

FIGS. 3 and 4 are analogous to FIGS. 1 and 2 respectively, and further provide a conduit 136 through stopper 130 or 130′. A mouthpiece 140 may further be provided, which can be of any suitable structure. As shown, mouthpiece body 140 is unitarily formed from stopper 130 or 130′ and a snap top 142 is attached thereto. The embodiment of FIG. 4 illustrates a pull embodiment for the stopper, rather than the push embodiment shown in FIG. 2. By extending the length of stopper 130, a push embodiment would result. A portion of stopper 130 would then extend above support structure 110. In such a push embodiment, conduit 136 need not extend completely through stopper 130 as shown. Instead, one or more ports may be provided (not shown), preferably in the extended portion of the stopper. Accordingly, when the stopper is pushed down, and mixing substance is released into the bottle, the ports would be positioned within the reservoir, and fluid may be drawn through the ports into the conduit and subsequently into the mouthpiece.

In any of the above embodiments, the mixing substance 300 may be any suitable composition, and the identity of the composition does not form part of the present invention per se. However, the mixing substance in reservoir 120 is preferably pre-metered for bottles of known capacity. For instance, standard bottles of 16 oz size may be used and the mixing substance is provided at an appropriate quantity for such bottles. Preferably, the final fluid composition is a beverage, such as a flavored drink mix, or a dietary supplement in substantially liquid form. The mixing substance is preferably in dry powder or crystal form. Preferably, the liquid provided in bottle 200 is water.

If desired, bottles may be provided in combination with the present invention, which may be reused instead of discarded after each beverage is consumed. Fluid fill lines may then be provided to offer increased precision in preparing the fluid composition. Only the bottle cap reservoir need be replaced to reuse these combinations.

It is to be understood that the present invention is not limited to the embodiments described above, but encompasses any and all embodiments within the scope of the following claims.

I claim:

1. A bottle cap drink mix dispenser including:
a reservoir for a mixing substance, said reservoir having an aperture;
a stopper sized to engage said aperture of said reservoir such that in one position a seal is formed between said aperture and said stopper, and in another position sufficient space is formed between said aperture and said stopper for said mixing substance to be dispensed from said reservoir; and
a support structure enclosing said reservoir and supporting said stopper such that relative movement is allowed between said stopper and said aperture; the support structure further adapted to be secured upon a bottle.

2. The bottle cap drink mix dispenser of claim 1 wherein said support structure and said stopper are rigidly attached, and said reservoir is slideably engaged within said support structure.

3. A bottle cap drink mix dispenser according to claim 2, for adfixing to a threaded bottle and dispensing a pre-metered mix into the bottle, wherein said support structure further comprises an interiorly threaded portion for engaging thread upon the threaded bottle.

4. A bottle cap drink mix dispenser according to claim 3, for adfixing to a threaded lipped bottle, wherein said support structure further comprises a removable skirt portion for engaging a lip of said threaded lipped bottle.

5. The bottle cap drink mix dispenser of claim 1 wherein said support structure and said reservoir are rigidly attached, and said stopper is slideably engaged to said support structure.

6. The bottle cap drink mix dispenser of claim 1 wherein said stopper further comprises: a conduit therethrough; and a closeable mouthpiece in fluid communication with said conduit.

7. The bottle cap drink mix dispenser of claim 1 wherein said stopper is tapered.

8. The bottle cap drink mix dispenser of claim 7 wherein said aperture of said reservoir has a taper matching said stopper.
